(19) United States
(12) Patent Application Publication
(10) Pub. No.: US 2011/0175249 A1
(43) Pub. Date: Jul. 21, 2011

(54) Polyester monofilament, method for producing same, and method for producing screen gauze using same

(76) Inventors: Hirofumi Yamamoto, Shizuoka (JP); Shinnosuke Tomita, Shizuoka (JP); Hiroyuki Kurokawa, Shizuoka (JP); Kiyoshi Akazawa, Shizuoka (JP); Kazuhiko Fukasawa, Shizuoka (JP)

(21) Appl. No.: 12/998,206

(22) PCT Filed: Sep. 10, 2009
(86) PCT No.: PCT/JP2009/065794

§ 371 Date: Mar. 25, 2011

(30) Foreign Application Priority Data
Sep. 26, 2008 (JP) 2008-248239
Sep. 30, 2008 (JP) 2008-254337

(51) Int. Cl. D04B 1/04; B29C 47/90; D02G 3/00

(52) U.S. Cl. 264/103; 264/211.17; 428/373

(57) ABSTRACT

There is provided a core-sheath bicomponent polyester monofilament, wherein a core component is composed of polyethylene terephthalate (PET) and a sheath component composed of PET having an intrinsic viscosity (IV) at least 0.2 lower than that of the core component, the polyester monofilament having a fineness of 3 to 8 dtex, a strength of 7.5 cN/dtex or more, a toughness (strength×elongation^{0.5}) of 29 or more, and a longitudinal yarn fineness variation of 1.5% or less.

### TECHNICAL FIELD

The present invention relates to a polyester monofilament suitable for high mesh density screen mesh cloth of 400 mesh (mesh: the number of yarn per inch (2.54 cm)) or larger, a method for producing a polyester monofilament, and a method for producing screen mesh cloth using the polyester monofilament.

### BACKGROUND ART

In the past, mesh cloths made of natural fibers such as silk or inorganic fibers such as stainless wires were widely used for screen printing cloth. However, mesh cloths made of synthetic fiber, which have excellent flexibility, durability, and cost performance, have been widely used in recent years. Particularly, a mesh cloth made of polyester monofilaments is being used in printing of graphic designs such as a compact disc label and in printing of electronic circuit boards, because it has high suitability for screen mesh cloth, for example, excellent dimensional stability.

Recently, performance improvement and downsizing of electronic devices have been significantly progressing. To meet the demand for downsizing of electronic boards which constitute the electronic devices and for more precise circuit boards, there has been an increasing need for screen mesh cloth that is of higher mesh density and has less woven fabric drawbacks such as uneven fiber diameter. Therefore, a polyester monofilament that satisfies the demand characteristics of these screen mesh cloths requires finer fineness and higher strength as well as excellent uniformity in fiber diameter and no occurrence of defects such as scum during weaving.

For example, the polyester monofilament whose core component and sheath component are both PET, as described in Patent Document 1, has a high breaking strength and causes less scum formed by abrasion of monofilament surfaces and dents during weaving. However, because the monofilament embodied in the examples has a fineness of as high as 10.0 dtex, it was unsuitable for obtaining high mesh density screen mesh cloth of 400 mesh or larger.

Patent Document 2 discloses the invention with finer fineness and higher strength than the one in Patent Document 1. However, because the finer fineness and higher strength significantly reduce elongation, the toughness illustrated in the examples was as low as about 27 and yarn was easily broken by even a small change in tension during warping or weaving. Consequently, it was difficult to stably produce high mesh density screen mesh cloth of 400 mesh or larger with this polyester monofilament.

Patent Document 3 discloses the invention with a fineness of 6 dtex, a strength of 8.0 cN/dtex and a toughness of 33. However, attempting to obtain a monofilament with fine fineness and high toughness by the method illustrated or described in the specification results in large variation in longitudinal yarn fineness. Therefore, while in the case of the screen mesh cloth of about 355 mesh illustrated in the examples, unevenness was inconspicuous, in the case of the screen mesh cloth of 400 mesh or larger, significant printing unevenness occurred and such screen mesh cloth obtained was unfit for practical use.

Patent Document 4 describes in Example 2 thereof a production method in which a polyester monofilament for screen mesh cloth having a fineness of 12.0 dtex, when being subjected to melt spinning, is drawn by a two-step process under conditions where spinning temperature is 298° C., length of a heating cylinder arranged immediately below a spinneret is 10 cm, temperature of the inner wall of the heating cylinder is 300° C., distance between yarn and the inner wall of the heating cylinder is 4.5 cm, and take-up speed is 850 m/min. This method, which is intended for monofilaments with a large fineness, cannot provide high toughness, because the length of a heating cylinder is too short with respect to discharge amount per single orifice which is estimated to be 4.6 g/min. In addition, because the take-up speed is high and the production is carried out by two-step process, even if the discharge amount per single orifice is reduced and the fineness is decreased, the physical properties of the polyester monofilament of the present invention cannot be obtained.

### Patent Document 1

JP 2005-47020 A (Claims, Examples)

### Patent Document 2

JP 2003-213520 A (Claims, Examples)

### Patent Document 3

JP 2005-240266 A (Claims, Examples)

### Patent Document 4

JP 2006-169680 A (Examples)

### SUMMARY OF THE INVENTION

### Problems to be Solved by the Invention

An object of the present invention is to provide a polyester monofilament that can solve the above-described problems and simultaneously achieve fine fineness, high strength, and high toughness with which high-mesh screen mesh cloth used in highly-precise screen printing can be obtained, a method for producing the same, and a method for producing screen mesh cloth using the polyester monofilament.

### Means for Solving the Problems

The present invention for achieving the above-described object employs the constitution as follows:
(1) a core-sheath bicomponent polyester monofilament, wherein a core component is composed of polyethylene terephthalate (PET) and a sheath component is composed of PET having an intrinsic viscosity (IV) at least 0.2 lower than that of the core component, the polyester monofilament having a fineness of 3 to 8 dtex, a strength of 7.5 cN/dtex or more, a toughness (strength×elongation^{0.5}) of 29 or more, and a longitudinal yarn fineness variation of 1.5% or less;
(2) the polyester monofilament according to (1), wherein large diameter portions which are at least 20% larger than the average fiber diameter of a monofilament cross-section are present at a frequency of not more than 1 in 100,000 m;
(3) a method for producing a polyester monofilament having a fineness of 3 to 8 dtex, wherein each polyethylene terephthalate of the core component and the sheath component is individually molten; yarn which is spun through a bicomponent spinneret via a spin pack mounted on a spin block is passed through a heating cylinder which is arranged immediately below a spinneret face and sequentially with the spin block, solidified by cooling, and provided with a spinning oil solution; and undrawn yarn taken up by a take-up roll is drawn without once being wound and then wound; these steps being performed under conditions where a temperature of an inner wall of the heating cylinder, T, is 270 to 325° C., a distance between the spinneret face and a lower end of the heating cylinder, L1, and a length of the heating cylinder, L2, satisfy the following equation, and a speed of the take-up roll is 300 to 800 m/min:

120≦L1 (mm)≦(−0.78×Q−2.56)×T+(294×Q+980)50≦L2 (mm)
Q: discharge amount per discharge orifice (g/min)
T: temperature of inner wall of heating cylinder (° C.);
(4) the method for producing a polyester monofilament according to (3), wherein total drawing magnification is 4.5 to 7.0 times and, drawing magnification at a first stage is 50 to 80% of the total drawing magnification;
(5) the method for producing a polyester monofilament according to (3) or (4), wherein an extruder-type extrusion machine is used in melting the polyethylene terephthalate of the core component and/or the sheath component, and a ratio of a final groove depth of an extruder screw, d2, to a distance between a tip of the extruder screw and a pipe wall surface, d1, d2/d1, is 0.5 to 1.5; and
(6) a method for producing screen mesh cloth in which the polyester monofilament according to (1) or (2) is used in an amount of 50% or more based on warp and/or weft.

### Effect of the Invention

A polyester monofilament having strength, toughness, and fiber diameter uniformity can be obtained. Excellent high mesh density screen mesh cloth can also be obtained by using this monofilament.

### BRIEF DESCRIPTION OF THE DRAWINGS

FIG. 1 is a schematic view of spinning equipment showing an embodiment of the present invention.

### BEST MODE FOR CARRYING OUT THE INVENTION

The present invention will now be described in detail.

Polyethylene terephthalate (PET) in the present invention refers to one in which 90 mol % or more of its repeating units are ethylene terephthalate. The polyester monofilament of the present invention is a core-sheath type bicomponent fiber whose core component and sheath component are both PET, and the intrinsic viscosity (IV) of the sheath component is at least 0.2 lower, preferably at least 0.3 lower than the IV of the core component. This enables lower degree of molecular orientation at a surface of the polyester monofilament obtained than in the case the IV of the sheath component is less than 0.2 lower than the IV of the core component or the case the IV of the sheath component is equal to or higher than the IV of the core component, so that fluffy or sticky scum due to abrasion with dents is unlikely to occur during weaving. Moreover, when the IV of the sheath component is at least 0.2 lower than the IV of the core component, the sheath component receives shear stress on an inner wall of a discharge orifice at a spinneret in melt spinning, thereby reducing the shear force that the core component will receive. Accordingly, the core component will be spun a low degree and uniform molecular chain orientation, so that there is an advantage in that the strength of polyester monofilaments finally obtained will be improved.

The IV of the core component PET, in terms of strengthening, is preferably 0.7 or more, and more preferably 0.8 or more. On the other hand, in terms of fluidity of molten polymers in melt spinning, the IV of the core component is preferably 1.4 or less, and more preferably 1.3 or less. The core component PET is mainly responsible for strength of a polyester monofilament, therefore, the amount of an inorganic particulate additive, represented by titanium dioxide, which is added to polyester fiber is preferably less than 0.5 wt. %.

While the IV of the sheath component PET needs to be 0.2 or more lower than the IV of the core component PET, it is preferably 0.4 or more in terms of stably measuring in a melt extruder or a spinneret. The sheath component PET is mainly responsible for abrasion resistance of a polyester monofilament, therefore, inorganic particulate represented by titanium dioxide is preferably added in an amount of 0.1 to 0.5 wt. %.

Further, copolymerizable components may be added to either the core component PET or the sheath component PET as long as the effects of the present invention are not adversely affected. Examples of the copolymerizable components as an acid component include, bifunctional aromatic carboxylic acids such as isophthalic acid, phthalic acid, dibromoterephthalic acid, naphthalenedicarboxylic acid, and diphenylxyentane carboxylic acid, and oxyethoxybenzoic acid, bifunctional aliphatic carboxylic acids such as sebacic acid, adipic acid, and oxalic acid, and cyclohexanedicarboxylic acid. Examples of the copolymerizable components as a glycol component include propanediol, butanediol, neopentylglycol, bisphenol A, and polyoxyalkylene glycols such as polyethylene glycol and polypropylene glycol. In addition, additives such as antioxidants, antistatic agents, plasticizers, ultraviolet absorbers, and coloring agents may be added as appropriate to either the core component PET or the sheath component PET.

The sheath/core area ratio in a fiber cross-section of the polyester monofilament of the present invention is preferably 40/60 to 5/95. As mentioned above, the core component is responsible for strength and the sheath component responsible for abrasion resistance, therefore, both of them can be simultaneously achieved without being adversely affected as long as the ratio is within the range. More preferably, the ratio is from 30/70 to 10/90.

The polyester monofilament of the present invention has a fineness of 3 to 8 dtex. To obtain high mesh density screen mesh cloth preferably of 400 mesh or larger, more preferably of 450 mesh or larger, which is suitable for precise printing, the fineness is 8 dtex or less. Conventional relatively high mesh density screen mesh cloth is of about 250 to 350 mesh, for which monofilaments having a fineness of 10 to 20 dtex are used. However, for example, high mesh density screen mesh cloth of 400 mesh (400 yarn per inch (2.54 cm)) has a mesh grid interval per yarn of about 63 μm, and the interval between fibers of screen mesh cloth having a fineness of 10 dtex, when calculated based on the gravity of common polyester fibers, 1.38 g/cm³, is about 30 μm, which is about 50% of one grid of the screen mesh cloth of 400 mesh, resulting in an extreme decrease in the clearance between a reed and polyester monofilaments, so that scum due to abrasion of dents and polyester monofilaments is likely to occur. As a result, high mesh density screen mesh cloth of 400 mesh or larger will not be obtained. Therefore, the upper limit of the fineness of the polyester monofilament of the present invention is 8 dtex, and more preferably 6.5 dtex or less. The lower limit of the fineness is 3 dtex or more, and more preferably 4 dtex or more for sufficient weavability, especially weft transportability.

The level of the strength of the polyester monofilament of the present invention that can sufficiently resist loads during a weaving process for obtaining high mesh density screen mesh cloth from polyester monofilaments having a fine fineness of 3 to 8 dtex and loads applied in screen printing is 7.5 cN/dtex or more, preferably 8.0 cN/dtex or more, and more preferably 8.5 cN/dtex or more.

Breaking of yarn is determined by breaking strength and breaking elongation, and deformation by a fixed stress is associated with strength and deformation with a fixed length is associated with elongation. Hence, it can be said that yarn with a reduced breaking elongation is fragile and likely to break, even if the above mentioned strength, 7.5 cN/dtex, is achieved. Therefore, resistance to breaking should be expressed by a parameter that considers both strength and elongation, not either of them. For example, integrated values of a curve up to breaking in stress-strain curve of a tensile test are applicable thereto, though the use of toughness (strength×elongation^{0.5}) as a convenient index would provide good correlation therewith. To make polyester monofilaments having a fine fineness of 3 to 8 dtex into high mesh density screen mesh cloth and, furthermore, into one which withstands printing as screen mesh cloth, not only the strength needs to be 7.5 cN/dtex, but also the toughness needs to be 29 or more as described above. The toughness is preferably 31 or more, and more preferably 32 or more. Though the polyester monofilament of the present invention need at least satisfy the strength of 7.5 cN/dtex or more and the toughness of 29 or more, the elongation of 11% or more is preferable, because it can stabilize weavability, especially stabilize tension in introducing weft, whereby breakage is unlikely to occur.

The longitudinal yarn fineness variation of the polyester monofilament of the present invention is, in terms of print quality when making it into high mesh density screen mesh cloth of 400 mesh or larger and subjecting it to precise printing, and of uniformizing strength and elongation of each yarn constituting a mesh, preferably 1.5% or less, more preferably 1.0% or less, and still more preferably 0.7% or less.

USTER TESTER (USTER) is commonly used in evaluating fiber fineness unevenness in the longitudinal direction of yarn, but when measuring yarn having a fine fineness of 3 to 8 dtex such as the polyester monofilament of the present invention, it cannot thoroughly detect fineness unevenness actually present because the minimum limit of detection of the tester is 10 dtex. Therefore, to evaluate fineness unevenness of a polyester monofilament of 3 to 8 dtex, fiber diameter data measured by an optical outer diameter measuring instrument are taken continuously in the longitudinal direction of yarn, and the data are computed according to the method described in Examples below to obtain longitudinal yarn fineness variation (%). This method has been shown to exhibit substantially the same value as the USTER value (normal) measured by USTER TESTER.

For fiber diameter uniformity, it is preferred that longitudinal yarn fineness variation be 1.5% or less as described above and, in addition, local large diameter portions which have a diameter at least 20% larger than the average fiber diameter of the monofilaments be present at a frequency of not more than 1 in 100,000 m. If the local large diameter portions are present at a frequency of not more than 1 in 100,000 m, better screen mesh cloth quality will be provided, so that print defects are unlikely to occur. More preferably, the frequency is not more than 0.5 in 100,000 m.

By using the above-mentioned polyester monofilament of the present invention in an amount of 50 wt. % or more based on warp and/or weft, screen mesh cloth suitable for highly precise printing can be obtained. By so doing, printing precision as screen mesh cloth will be improved and, in addition, when used as warp, print defects due to scum can be prevented, and when used as weft, high quality screen mesh cloth can be woven stably without undergoing weft breakage while being of fine fineness.

Screen mesh cloth may be produced by using a conventional method, in which weaving is carried out by the system in which weft is mechanically held and transported using a shuttle loom such as a Sulzer loom and a rapier loom, and then scouring, dyeing, and heat setting are carried out as required. Plasma treatment or chemical treatment may also be carried out for the purpose of modifying the electrostatic property and wettability of screen mesh cloth.

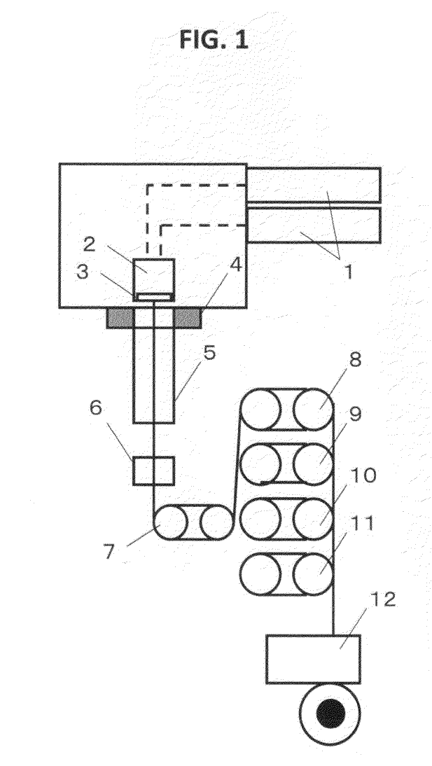

FIG. 1 shows an example of apparatuses in the method for producing the polyester monofilament of the present invention. First, the core component PET and the sheath component PET are each molten and extruded using an extruder-type extrusion machine, and the desired discharge amount was weighed with a measuring pump (not shown) to be guided to a spin pack mounted in a spin block. The molten polymers are passed through, for example, a filter (not shown) embedded within the spin pack, and then discharged in the core-sheath form from a discharge orifice at a bicomponent spinneret embedded within the spin pack. The yarn spun through the spinneret discharge orifice is passed through a heating cylinder which is arranged immediately below a spinneret face and sequentially with the spin block, and then solidified by cooling with a cooling apparatus based on, for example, a cooling air-blowing system. The yarn solidified by cooling is provided with an oil solution by a weighing and oiling apparatus such as an oiling roll, and then taken up by a godet roll 1.

To obtain the polyester monofilament of the present invention, melt spinning by a conventional method may be used, while bearing in mind (1) to (5) below during the process from melting to take-up:
(1) It is preferred that PET melt-transit time from melting to immediately before spinning and heating temperature be minimized to suppress the decrease in molecular weight of PET;
(2) Preferably, an extruder-type extrusion machine is used as a melt extruder, and a ratio of a final groove depth of an extruder screw, d2, to a distance between a tip of the extruder screw and a pipe wall surface, d1, d2/d1, is 0.5 to 1.5;
(3) Take-up speed of a godet roller is 300 to 800 m/min to suppress the increase in the degree of molecular orientation of spun yarn;
(4) A heating cylinder is embedded immediately below the spinneret to maintain the temperature of the inner wall at 270 to 325° C. and suppress the increase in the degree of molecular orientation of spun yarn due to drawing deformation; and
(5) Spinning draft (=take-up speed/average linear speed in spinneret discharge orifice) is preferably 100 or less, more preferably 70 or less, to slow down spun yarn's deformation on a spinning line and suppress the degree of molecular orientation of spun yarn.

In terms of improving strength and toughness of a polyester monofilament to be obtained, it is preferable, as in (1), to suppress the decrease in molecular weight of PET due to hydrolysis as few as possible. Particularly, it is preferred that the temperature at which PET is molten and held be 300° C. or less and that the average time for melting and holding PET be 20 minutes or less. This improves the toughness and at the same time suppresses the generation of gelatinous compounds which is an oxidative degradation product of PET, thus reducing local large diameter portions of a monofilament, which results in improved fiber diameter uniformity.

As an alternative means to reduce local large diameter portions of a monofilament, it is preferable, as in (2), to use an extruder-type extrusion machine. An extruder-type extrusion machine provides an ideal piston flow during the period from PET supply in the solid state to its melting and extruding, thereby narrowing the detention time distribution, which suppresses generation of gelatinous compounds. For a shape of a tip of this extruder-type extrusion machine, a ratio of a final groove depth of an extruder screw, d2, to a distance between the tip of the screw and a pipe wall surface, d1, d2/d1, is preferably 0.5 to 1.5. In general, the capacity of an extruder screw suddenly becomes larger from the final groove to the tip, thereby extremely reducing the flow rate of molten PET to cause abnormal detention, which can generate gelatinous compounds. In particular, when fineness is low as in the polyester monofilament of the present invention, the extrusion rate of the extruder necessarily decreases so that the abnormal detention is likely to be actualized. Therefore, to suppress the decrease in the flow rate from a final groove to a tip of a screw, a ratio of the final groove depth of the extruder screw, d2, to a distance between the tip of the screw and a pipe wall surface, d1, d2/d1, is preferably 0.5 to 1.5.

To maximize the strength and toughness of a monofilament to be obtained, spun yarn having a small degree of molecular orientation in a spinning process is preferably oriented at high drawing magnification in a drawing process. Specifically, it is effective, as in (3) to (5), to suppress the degree of molecular orientation of spun yarn as few as possible. Briefly, the stronger the strength “to draw” in spinning is, the greater the degree of molecular orientation of discharged yarn will be. Forces acting on a spinning line include a tensile force due to take-up speed and a resistance to deformation due to elongational viscosity or air resistance, but in the case of a monofilament, air resistance is so extremely small that it is almost ignorable. When spinning to obtain a polyester monofilament having a fineness of 3 to 8 dtex by a conventional method, spun yarn is easily cooled as it is thin, and the degree of molecular orientation of the spun yarn becomes large as the resistance to deformation becomes large, thus making it difficult to achieve a strength of 7.5 cN/dtex or more and a toughness of 29 or more. To reduce the tensile force due to take-up speed, (3) take-up speed of a godet roller may be reduced. The speed of 300 to 800 m/min, preferably to 600 m/min, can be employed to obtain the monofilament of the present invention. To reduce the resistance to deformation due to elongational viscosity, in terms of raising yarn temperature in elongational deformation and reducing elongational viscosity, (4) it is necessary to keep the atmosphere immediately below a spinneret at 270 to 325° C. by heat. Preferably, (5) spinning draft is low, specifically preferably 100 or less, and more preferably 70 or less. These can further improve the toughness of a polyester monofilament to be obtained.

When obtaining the polyester monofilament of the present invention, excessively elevated temperature or excessively long length of the heating cylinder in (4) would give excessive heat to the polyester monofilament, resulting in loss of fiber diameter uniformity. Therefore, it is especially important to properly set these conditions according to the fineness, i.e., discharge amount per single orifice of a polyester monofilament to be obtained. That is, for the length of a heating cylinder, it is important that a distance between a spinneret face and a lower end of the heating cylinder, L1, and a length of the heating cylinder, L2, satisfy the following equation:

120≦L1 (mm)≦(−0.78×Q−2.56)×T+(294×Q+980)50≦L2 (mm)
Q: discharge amount per single discharge orifice (g/min)
T: temperature of inner wall of heating cylinder (° C.).

When the distance between the spinneret face and the lower end of the heating cylinder, L1, is smaller than the lower limit of the above equation, the elongational viscosity becomes high and the toughness does not improve, and when it is larger than the upper limit of the above equation, yarn immediately below the spinneret will be held in a semi-molten state for a long time, resulting in that fiber diameter uniformity cannot be maintained under the influence of yarn swaying between the spinneret and a take-up roll.

An object of the heating cylinder is to heat the atmosphere in the heating cylinder through which yarn passes. However, when the length of the heating cylinder, L2, is smaller than the lower limit of the above equation, the length of L2 in L1 is too short, so that the original object of the heating cylinder cannot be achieved.

The distance between spun yarn and the inner wall of the heating cylinder is preferably 15 mm or more, further 20 mm or more distant from the diameter of the concentric circle, on which the discharge orifice is arranged, in the direction of increase of the diameter. It can be easily imagined that the temperature of the atmosphere in the heating cylinder is the highest at the side of the inner wall of the heating cylinder and gradually decreases toward the center of the heating cylinder, considering that it is heated by the inner wall of the heating cylinder. The investigation of the temperature of the atmosphere in the heating cylinder proved that there is a steep temperature gradient within 15 mm from the inner wall of the heating cylinder. Therefore, by separating the inner wall of the heating cylinder by 15 mm or more from the diameter of the concentric circle, on which the discharge orifice is arranged, in the direction of increase of the diameter, spun yarn passes through the atmosphere in the heating cylinder with a relatively gentle temperature gradient. As a result, even if yarn route change by, for example, yarn swaying, the state of heating from the atmosphere in the heating cylinder in the longitudinal direction of yarn will not change, so that variation in fiber diameter in the longitudinal direction is unlikely to occur.

In the process of drawing/winding for obtaining the polyester monofilament of the present invention, yarn spun and taken up is drawn between a heating roller heated to a glass transition point or higher and a drawing roller heated to a crystallization temperature or higher, and wound into the form of pirn or cheese. To maximize the toughness of a polyester monofilament to be obtained, the following points are mainly to be noted:
(6) In terms of reducing the fineness unevenness and the variation of physical properties of a monofilament to be obtained, spin-draw, in which undrawn yarn is directly drawn without winding undrawn yarn, is performed;
(7) Drawing is performed by multistage drawing with three pairs or more of rollers, and the drawing magnification ratio of the first stage is preferably 50 to 80%;
(8) The temperature of the drawing rollers before the final drawing roller is preferably 130° C. or less, more preferably 110° C. or less, to suppress crystallization during drawing; and
(9) The temperature of the final drawing roller is preferably 180° C. or more, more preferably 200° C. or more, to increase the crystallinity of a polyester monofilament to be obtained.

The spun yarn obtained by the above-mentioned melt spinning method has an extremely low degree of orientation, and therefore, once wound as undrawn yarn, it undergoes a change with time in molecular orientation/crystalline state until it is drawn, so that variation is likely to occur longitudinally. In particular, to achieve fine fineness and high strength as in the polyester monofilament of the present invention, undrawn yarn of fine fineness is subjected to drawing at high magnification of 4.5 to 7.0 times, hence the difference in molecular orientation/crystalline state among undrawn yarns is likely to be actualized as longitudinal yarn fineness variation. If drawing is performed while keeping the undrawn yarn's molecular orientation/crystalline state uniform, the longitudinal yarn fineness variation or the variations of physical properties can be reduced, and therefore, (6) spin-draw, in which yarn is subjected to drawing immediately after spinning without winding undrawn yarn, is performed.

Further, to uniformly draw the undrawn monofilament yarn having a low degree of orientation/fine fineness, as in (7) and (8), the multistage drawing in which magnification ratio of the first stage is 50 to 80% is preferably performed, and the heating temperature of the drawing rollers before the final drawing roller is preferably 130° C. or less, and more preferably 110° C. or less. The upper limit of the number of rollers is not restricted, and three pairs or more of hot rollers will similarly provide the effect of multistage drawing, although extremely increasing the number will lead to complication of an apparatus, so that about three or four pairs are generally enough. For a hot roll, either one-hot roll and one-separate roll configuration or two-hot roll configuration (so called duo type) may be used, and in duo type, two hot rolls are to be counted as one pair.

Furthermore, (9) the final drawing roller temperature for increasing the crystallinity of a polyester monofilament to be finally obtained and providing high toughness is preferably 180° C. or more, and more preferably 200° C. or more. Additional several godet rollers may also be arranged between the final drawing roller and a winder. If negative speed difference is imparted between the final drawing roller and the godet rollers, strains at molecular amorphous site generated by drawing can be reduced, thereby providing the effect of enhancing elongation to improve toughness and the effect of improving abrasion resistance to form less scum. On the other hand, if positive speed difference is imparted between the final drawing roller and the godet rollers, the improved initial elastic modulus of a polyester monofilament to be obtained reduces the misalignment occurring when the polyester monofilament is used in printing as high mesh density screen mesh cloth, resulting in improved printing precision. The choice between them may be appropriately determined in view of the demand characteristics of each printing application.

At any point in the process for obtaining the polyester monofilament of the present invention, an oil solution is preferably added for the purpose of improving the smoothness, abrasion resistance, and antistaticity of a polyester monofilament to be obtained. Oiling systems include an oiling guide system, oiling roller system and spray system, and oil may be fed more than once during the period from spinning to winding.

The method for producing the polyester monofilament of the present invention which has been described above simultaneously achieve fine fineness, high strength, high toughness, and less longitudinal yarn fineness variation, and cannot be readily inferred from methods described in conventional inventions. Comparison with the prior art will be described below.

Patent Document 4 describes in Example 2 thereof a production method in which a polyester monofilament for screen mesh cloth having a fineness of 12.0 dtex, when being subjected to melt spinning, is drawn by a two-step process under conditions where spinning temperature is 298° C., length of a heating cylinder arranged immediately below a spinneret is 10 cm, temperature of the inner wall of the heating cylinder is 300° C., distance between yarn and the inner wall of the heating cylinder is 4.5 cm, and take-up speed is 850 m/min. This method is intended for monofilaments with a large fineness, and the discharge amount per single orifice is estimated to be 4.6 g/min. When compared to the method of the present invention, the length of a heating cylinder is too short with respect to discharge amount per single orifice to provide high toughness. In addition, because the take-up speed is high and the production is carried out by two-step process, even if the discharge amount per single orifice is reduced and the fineness is decreased, the physical properties of the polyester monofilament of the present invention cannot be obtained.

Patent Document 1 describes in Example 1 thereof a production method in which a polyester monofilament for screen mesh cloth having a fineness of 10.0 dtex, when being subjected to melt spinning, is drawn by a two-step process under conditions where length of a heating cylinder arranged immediately below a spinneret is 10 cm, temperature of the inner wall of the heating cylinder is 300° C., distance between yarn and the inner wall of the heating cylinder is 4.5 cm and take-up speed is 850 m/min, and in Comparative Example 4 thereof the same production method as in Example 1 except that take-up speed is 600 m/min. Calculating from the drawing magnification described, the discharge amount per single orifice in Example 1 and Comparative Example 4 are estimated to be 3.8 g/min and 2.7 g/min, respectively. When compared to the method of the present invention, the length of the heating cylinder is too short with respect to discharge amount per single orifice to provide high toughness. In addition, because the production is carried out by two-step process, even if the discharge amount per single orifice is reduced and the fineness is decreased, the physical properties of the polyester monofilament of the present invention cannot be obtained.

Patent Document 3 describes in Example 1 thereof a production method in which a 6 dtex polyester monofilament for screen mesh cloth, when being subjected to melt spinning, is drawn by a two-step process under conditions where length of a heating cylinder is 10 cm, temperature of the inner wall of the heating cylinder is 300° C., distance between yarn and the inner wall of the heating cylinder is 4.5 cm, and a take-up speed is 850 m/min. In this method, the production is carried out by two-step process, and therefore longitudinal yarn fineness variation becomes large. Therefore, when this method is used to obtain screen mesh cloth, no significant problem occurs in the case of about 355 mesh as exemplified, but in the case of high mesh density screen mesh cloth of 400 mesh or larger, the screen mesh cloth obtained is unpractical for use because of the significant irregularities in printing.

### EXAMPLES

The present invention will now be described in more detail by way of Examples. The evaluation in Examples was in accordance with the following method.

(Intrinsic Viscosity: IV)

The measurements were made at 25° C. after 0.8 g of a sample was completely dissolved in 10 ml of ortho-chlorophenol.

(Fineness)

Yarn was reeled by 500 m, and the value obtained by multiplying the weight of the hank by 20 was defined as fineness.

(Strength, Elongation, Toughness)

TENSILON tensile tester manufactured by ORIENTEC Co., LTD was used to measure the strength and elongation when breaking occurs under the conditions of an initial sample length of 20 cm and a pulling rate of 2 cm/min. Each measurement was made five times and the mean values were defined as strength (cN/dtex) and elongation (%). Toughness (strength×elongation^{0.5}) was calculated from these strength and elongation.

(Longitudinal Yarn Fineness Variation, Number of Large Diameter Portions)

The yarn obtained was passed at a speed of 500 m/min through a detecting element of a laser outer diameter measuring instrument KL1002A/E manufactured by Anritsu Corporation to obtain about 22,000 yarn diameter data in 120 seconds under the condition where the number of data for averaging was 16. The obtained yarn diameter data r (μm) was converted to longitudinal yarn fineness variation (%) by the following equation.

$$X = \frac{1}{n} \sum \vert \frac{{r}_{ave}^{2} - {r}_{i}^{2}}{{r}_{i}^{2}} \vert \times 100 \qquad [ Equation 1 ]$$

Wherein, n: numbers of data, rₐᵥₑ:average of rᵢ, rᵢ:i-th data of r

For the number of large diameter portions, 1,000,000 m of yarn was passed through the detecting element under the same measurement condition to count the number of peaks which were at least 20% larger than the average fiber diameter, and the value obtained by dividing the number of peaks by 10 was defined as the number of large diameter portions (number/100,000 m).

(Weaving Evaluation)

Mesh cloth of 480 mesh having a width of 2.2 m and a length of 300 m was woven by using a Sulzer weaving machine at 120 rpm. Paying attention to the state of thread breakage and stains on reed, evaluation was performed according to the following criteria. “Good” and “Fair” were evaluated as acceptable.
Good: good (thread breakage, five times or less; and no stains on reed)
Fair: a little bit poor, but good (at least one of the thread breakage and stains on reed are in the range between “Good” and “Fair”)
Poor: not mass-producible (thread breakage, 15 times or more, or continuous weaving is impossible because of significant stains on reed)

(Printing Evaluation)

On the mesh cloth obtained, 50 μm of line patterns were formed at an interval of 50 μm with a photosensitive emulsion. The state after printing was observed and evaluated according to the following criteria.
Good: line reproducibility is good; Fair: irregularities are observed at boundaries of lines, but no problem; Poor: poor

### Example 1

PET which was polymerized and pelletized by a conventional method and has an intrinsic viscosity (IV) of 1.15, and PET which has an intrinsic viscosity (IV) of 0.63 and contains 0.3 wt. % of titanium oxide were molten by separate extruder-type extrusion machines (d1/d2=1.1) such that the former was the core component and the latter was the sheath component. The molten PET was passed through piping kept at 290° C., after which core-sheath type bicomponent yarn was spun through a known core-sheath type bicomponent spinneret at a discharge amount per single orifice of 1.3 g/min such that the area ratio of core:sheath was 8:2. The discharged yarn was positively warmed with a heating cylinder in which the distance between a spinneret face and the lower end of the heating cylinder, L1, was 170 mm; the heating cylinder length, L2, was 100 mm; the inner diameter of the heating cylinder was 89 mm; the inner wall temperature of the heating cylinder was 299° C. (the temperature of the atmosphere in the heating cylinder was 293° C.); and the distance between the inner wall of the heating cylinder and a discharge orifice was 52 mm, and then cooled to solidify by blowing 25° C. of air thereto at a wind speed of 10 m/min. The yarn cooled to solidify was provided with a spinning oil solution by an oiling roll, and then passed through a godet roll 1 (mirror surface) having a surface speed of 500 m/min, a hot roll 2 (mirror surface) having a surface speed of 505 m/min and a surface temperature of 90° C., a hot roll 3 (mirror surface) having a surface speed of 1800 m/min and a surface temperature of 100° C., a hot roll 4 (mirror surface) having a surface speed of 2930 m/min and a surface temperature of 220° C., and a godet roll 5 (mirror surface) having a surface speed of 2959 m/min, after which a polyester monofilament was wound with a yarn-winding apparatus, the speed of which was controlled such that winding tension was 0.5 g. In this case, spinning draft was 64; total drawing magnification was 5.8 times; and magnification ratio of the first stage (the first stage drawing magnification/total drawing magnification×100) was 62%. The schematic view of the silk-reeling process is shown in FIG. 1.

The monofilament obtained had a fineness of 4.5 dtex, a strength of 9.1 cN/dtex, an elongation of 13.1%, a toughness of 32.9, a longitudinal yarn fineness variation of 0.49%, and the number of large diameter portions of 0.1/100,000 m. The weaving evaluation using the polyester monofilament obtained showed good results that there was almost no occurrence of scum and thread breakage, while the printing evaluation showed good reproducibility of lines.

### Examples 2 to 4, Comparative Example 1

Polyester monofilaments were obtained in the same manner as in Example 1 except that the fineness of polyester monofilaments to be obtained was changed as in Table 1. In Example 4, although the printing evaluation showed some disarray in reproduction of lines, the polyester monofilament obtained had a satisfactory printing performance. In Comparative Example 1, however, not only scum-like defects occurred in weaving, but the printing evaluation showed poor reproducibility of lines.

### Examples 5 to 7, Comparative Example 2

Polyester monofilaments were obtained in the same manner as in Example 2 except that the IV of PET to be used as a material was changed as in Table 1. In Example 7, the strength and toughness slightly reduced, so that thread breakage occurred in weaving and, in addition, printing evaluation showed a decreased printing precision, but the polyester monofilament obtained had a satisfactory performance. On the other hand, in Comparative Example 2, the polyester monofilament obtained was unpractical for use because scum generated frequently in weaving.

The results of Examples 1 to 7 and Comparative Examples 1 and 2 are shown in Table 1.

TABLE 1

| | | | | | | Ex- | Ex- | Comparative | Ex- | Ex- | Ex- | Comparative |
|---|---|---|---|---|---|---|---|---|---|---|---|---|
| Item | | | Unit | Example 1 | Example 2 | ample 3 | ample 4 | Example 1 | ample 5 | ample 6 | ample 7 | Example 2 |
| Polymer | Core | IV | — | 1.15 | 1.15 | 1.15 | 1.15 | 1.15 | 1.00 | 1.00 | 0.75 | 0.75 |
| Composition | component | TiO₂ | % | 0.0 | 0.0 | 0.0 | 0.0 | 0.0 | 0.0 | 0.0 | 0.0 | 0.0 |
| | | content | | | | | | | | | | |
| | Seath | IV | — | 0.63 | 0.63 | 0.63 | 0.63 | 0.63 | 0.50 | 0.75 | 0.50 | 0.60 |
| | component | TiO₂ | % | 0.3 | 0.3 | 0.3 | 0.3 | 0.3 | 0.3 | 0.3 | 0.3 | 0.3 |
| | | content | | | | | | | | | | |

| | | | | | | | | | | | |
|---|---|---|---|---|---|---|---|---|---|---|---|
| | Core/Seath ratio | — | 80/20 | 80/20 | 80/20 | 80/20 | 80/20 | 80/20 | 80/20 | 80/20 | 80/20 |
| Yarn | Fineness | dtex | 4.5 | 3.6 | 6.3 | 7.5 | 8.5 | 3.6 | 3.6 | 3.6 | 3.6 |
| Properties | Strength | cN/dtex | 9.1 | 9.2 | 8.9 | 8.9 | 8.8 | 8.9 | 9.2 | 7.7 | 8.1 |
| | Elongation | % | 13.1 | 12.6 | 13.8 | 14.3 | 14.8 | 13.2 | 13.2 | 14.5 | 14.1 |
| | Toughness | — | 32.9 | 32.7 | 33.1 | 33.7 | 33.9 | 32.3 | 33.4 | 29.3 | 30.4 |
| | Longitudinal Yarn | % | 0.49 | 0.65 | 0.41 | 0.37 | 0.33 | 0.65 | 0.61 | 0.67 | 0.64 |
| | Fineness Variation | | | | | | | | | | |
| | Number of Large | spots/ | 0.1 | 0.6 | 0 | 0 | 0 | 0.4 | 0.6 | 0.3 | 0.5 |
| | Diameter Portions | 100,000 m | | | | | | | | | |

| | | | | | | | | | | |
|---|---|---|---|---|---|---|---|---|---|---|
| Weaving Evaluation | — | Good | Good | Good | Good | Poor | Good | Good | Fair | Poor |
| Printing Evaluation | — | Good | Good | Good | Fair | Poor | Good | Good | Fair | Fair |

### Examples 8 and 9, Comparative Example 3

Polyester monofilaments were obtained in the same manner as in Example 1 except that the total drawing magnification was changed to 5.3 times, 5.0 times, 4.6 times, respectively, and the discharge amount was adjusted such that the fineness of a polyester monofilament yarn to be obtained was constant. Since the strength was reduced with a decrease in the drawing magnification, thread breakage during weaving increased in Example 8, and an increased thread breakage during weaving and a reduced printing precision were observed in Example 9, but the polyester monofilaments obtained had a satisfactory performance. On the other hand, in Comparative Example 3, because the strength was as low as 7.3 cN/dtex, thread breakage occurred so frequently during weaving that the weavability was poor to such an extent that the production was substantially impossible and, in addition, the printing precision was insufficient.

### Examples 10 to 12

Polyester monofilaments were obtained in the same manner as in Example 1 except that the amount of titanium oxide to be added to PET to be used as a material was changed as in Table 2. In Example 10, because the titanium oxide content in the core component was increased, a reduction of toughness and an increase in thread breakage during weaving were observed, but they were at a producible level. In Example 12, because the titanium oxide content in the sheath component was reduced, a decrease in abrasion resistance of the polyester monofilaments and an increase of scum in weaving were observed, but they were at a producible level.

The results of Examples 8 to 12 and Comparative Example 3 are shown in Table 2.

TABLE 2

| | | | | | | Comparative | | | |
|---|---|---|---|---|---|---|---|---|---|
| Item | | | Unit | Example 8 | Example 9 | Example 3 | Example 10 | Example 11 | Example 12 |
| Polymer | Core | IV | — | 1.15 | 1.15 | 1.15 | 1.15 | 1.15 | 1.15 |
| Composition | component | TiO₂ | wt % | 0.0 | 0.0 | 0.0 | 0.5 | 0.1 | 0.0 |
| | | content | | | | | | | |
| | Seath | IV | — | 0.63 | 0.63 | 0.63 | 0.63 | 0.63 | 0.63 |
| | component | TiO₂ | wt % | 0.3 | 0.3 | 0.3 | 0.3 | 0.3 | 0.1 |
| | | content | | | | | | | |

| | | | | | | | | |
|---|---|---|---|---|---|---|---|---|
| | Core/Seath ratio | — | 80/20 | 80/20 | 80/20 | 80/20 | 80/20 | 80/20 |
| Yarn | Fineness | dtex | 4.5 | 4.4 | 4.5 | 4.5 | 4.5 | 4.5 |
| Properties | Strength | cN/dtex | 8.1 | 7.6 | 7.3 | 8.8 | 8.9 | 9.1 |
| | Elongation | % | 17.0 | 19.6 | 21.5 | 12.1 | 12.8 | 13.0 |
| | Toughness | — | 33.4 | 33.6 | 33.8 | 30.6 | 31.8 | 32.8 |
| | Longitudinal Yarn | % | 0.45 | 0.44 | 0.44 | 0.51 | 0.55 | 0.49 |
| | Fineness Variation | | | | | | | |
| | Number of Large | spots/ | 0.1 | 0.1 | 0 | 0.2 | 0.1 | 0.1 |
| | Diameter Portions | 100,000 m | | | | | | |

| | | | | | | | |
|---|---|---|---|---|---|---|---|
| Weaving Evaluation | — | Fair | Fair | Poor | Fair | Good | Fair |
| Printing Evaluation | — | Good | Fair | Poor | Good | Good | Good |

### Example 13, Comparative Example 4

Polyester monofilaments were obtained in the same manner as in Example 1 except that the godet roll speed and the hot roll speed was changed as in Table 3 and the discharge amount was adjusted such that the fineness of polyester monofilaments to be obtained was constant. In Example 13, the polyester monofilament had a reduced toughness, but it had a satisfactory performance. On the other hand, in Comparative Example 4, the toughness was so significantly reduced that thread breakage during weaving occurred frequently and printing precision was significantly reduced as well, so that the polyester monofilament obtained was substantially unpractical for use.

### Examples 14 to 16

Polyester monofilaments were obtained in the same manner as in Example 1 except that, in Examples 14 and 15, the speed of the hot roll 2 was changed as in Table 3, and in Example 16, a single-stage drawing without being passed through the hot roll 2 was performed. Although, both the polyester monofilaments were confirmed in weaving evaluation and printing evaluation to have a satisfactory performance, in Example 15, thread breakage during weaving increased, and in Example 16, a reduced printing precision as well as an increased thread breakage during weaving was observed.

The results of Examples 13 to 16 and Comparative Example 4 are shown in Table 3.

TABLE 3

| | | | | Comparative | | | |
|---|---|---|---|---|---|---|---|
| Item | | Unit | Example 13 | Example 4 | Example 14 | Example 15 | Example 16 |
| Godet Roll 1 | Speed | m/min | 700 | 900 | 500 | 500 | 500 |
| Hot Roll 2 | Speed | m/min | 707 | 909 | 505 | 505 | 505 |
| Hot Roll 3 | Speed | m/min | 2150 | 2500 | 1450 | 2800 | — |
| Hot Roll 4 | Speed | m/min | 3490 | 4050 | 2930 | 2930 | 2930 |
| Godet Roll 5 | Speed | m/min | 3525 | 4091 | 2959 | 2959 | 2959 |

| | | | | | | | |
|---|---|---|---|---|---|---|---|
| Yarn | Fineness | dtex | 4.5 | 4.5 | 4.5 | 4.5 | 4.5 |
| Properties | Strength | cN/dtex | 8.8 | 8.5 | 9.1 | 9.1 | 8.9 |
| | Elongation | % | 12.2 | 11.2 | 11.1 | 10.9 | 10.8 |
| | Toughness | % | 30.7 | 28.4 | 30.3 | 30.0 | 29.2 |
| | Longitudinal Yarn | % | 0.40 | 0.31 | 0.51 | 0.88 | 1.21 |
| | Fineness Variation | | | | | | |
| | Number of Large | spots/ | 0 | 0 | 0.1 | 0.1 | 0.1 |
| | Diameter Portions | 100,000 m | | | | | |

| | | | | | | |
|---|---|---|---|---|---|---|
| Weaving Evaluation | — | Good | Poor | Good | Fair | Fair |
| Printing Evaluation | — | Good | Poor | Good | Good | Fair |

### Examples 17 to 20

Polyester monofilaments were obtained in the same manner as in Example 1 except that the temperature of the hot roll 3 and 4 was changed as in Table 4. In Examples 17 and 18, although a reduced toughness was observed with increasing temperature of the hot roll 3, the polyester monofilaments were maintained at a sufficient level. In Examples 19 and 20, although a reduced toughness was observed with decreasing temperature of the hot roll 4, the polyester monofilaments were maintained at a sufficient level.

The results of Examples 17 to 20 are shown in Table 4.

TABLE 4

| Item | | Unit | Example 17 | Example 18 | Example 19 | Example 20 |
|---|---|---|---|---|---|---|
| Hot Roll 2 | Temperature | ° C. | 90 | 90 | 90 | 90 |
| Hot Roll 3 | Temperature | ° C. | 120 | 140 | 100 | 100 |
| Hot Roll 4 | Temperature | ° C. | 220 | 220 | 200 | 170 |

| | | | | | | |
|---|---|---|---|---|---|---|
| Yarn | Fineness | dtex | 4.5 | 4.5 | 4.5 | 4.5 |
| Properties | Strength | cN/dtex | 8.7 | 8.6 | 8.9 | 8.6 |
| | Elongation | % | 12.5 | 12.0 | 12.2 | 11.8 |
| | Toughness | % | 30.8 | 29.8 | 31.1 | 29.5 |
| | Longitudinal Yarn | % | 0.51 | 0.58 | 0.52 | 0.42 |
| | Fineness Variation | | | | | |
| | Number of Large | spots/ | 0.1 | 0.1 | 0.1 | 0.1 |
| | Diameter Portions | 100,000 m | | | | |

### Comparative Examples 5 and 6

Polyester monofilaments were obtained by the two-step process in which undrawn yarn was spun, cooled, and provided with oil in the same manner as in Example 1 and then the yarn was subjected to drawing after being wound once. The undrawn yarn, which was obtained at a winding speed in spinning which was changed as in Table 5, was drawn by a drawing machine of 3-hot roll configuration under the conditions where the drawing magnification was changed as in Table 5; the drawing magnification ratio at the first stage was 0.7; the hot roll temperatures were 90° C., 100° C., and 220° C. from the first; and the final winding speed was 700 m/min. In Comparative Example 5, thread breakage by weaving was observed because the toughness was reduced compared to Example 1, and a reduced printing precision was observed because the longitudinal yarn fineness variation increased. On the other hand, in Comparative Example 6, the toughness was reduced still more than in Comparative Example 5, so that thread breakage during weaving occurred frequently, and besides, the printing precision was low. Both the polyester monofilaments obtained were substantially unpractical for use.

The results of Comparative Examples 5 and 6 are shown in Table 5.

TABLE 5

| | | | Comparative | Comparative |
|---|---|---|---|---|
| Item | | Unit | Example 5 | Example 6 |
| Spinning Speed | | m/min | 500 | 700 |
| Total Drawing Magnification | | times | 5.8 | 5.2 |
| Yarn | Fineness | dtex | 4.5 | 4.5 |
| Properties | Strength | cN/dtex | 8.6 | 8.4 |
| | Elongation | % | 12.1 | 11.4 |
| | Toughness | % | 29.9 | 28.4 |
| | Longitudinal Yarn | % | 1.61 | 1.21 |
| | Fineness Variation | | | |
| | Number of Large | spots/ | 0.3 | 0.1 |
| | Diameter Portions | 100,000 m | | |

| | | | |
|---|---|---|---|
| Weaving Evaluation | — | Fair | Poor |
| Printing Evaluation | — | Poor | Poor |

### Examples 21 and 22, Comparative Examples 7 and 8

Polyester monofilaments were obtained in the same manner as in Example 1 except that the temperature of the inner wall of a heating cylinder was changed as in Table 6. The toughness tended to be reduced with decreasing temperature of the inner wall of the heating cylinder, and in Example 21, it was sufficient at 30.7, but in Comparative Example 7, the toughness was significantly reduced to 28.7. The longitudinal yarn fineness variation tended to increase with increasing temperature of the inner wall of the heating cylinder, and in Example 22, it was sufficient at 1.01%, but in Comparative Example 8, it significantly increased to 1.72%.

The results of Examples 21 and 22 and Comparative Examples 7 and 8 are shown in Table 6.

TABLE 6

| | | | | | Comparative | | Comparative |
|---|---|---|---|---|---|---|---|
| Item | | Unit | Example 1 | Example 21 | Example 7 | Example 22 | Example 8 |
| Discharge amount per single orifice | | g/min | 1.3 | 1.3 | 1.3 | 1.3 | 1.3 |
| Innner Wall Temperature of the Heating Cylinder | | ° C. | 299 | 274 | 265 | 321 | 334 |
| Distance between the Spinnerete face and | | mm | 170 | 170 | 170 | 170 | 170 |
| a lower end of the Heating Cylinder L1 | | | | | | | |
| Length of the Heating Cylinder L2 | | mm | 100 | 100 | 100 | 100 | 100 |
| Distance between the Inner Wall of | | mm | 52 | 52 | 52 | 52 | 52 |
| the Heating Cylinder and the Discharge Orifice | | | | | | | |
| Yarn | Fineness | dtex | 4.5 | 4.5 | 4.5 | 4.5 | 4.5 |
| Properties | Strength | cN/dtex | 9.1 | 9.1 | 9.0 | 9.1 | 9.1 |
| | Elongation | % | 13.1 | 11.4 | 10.2 | 13.4 | 13.8 |
| | Toughness | % | 32.9 | 30.7 | 28.7 | 33.3 | 33.8 |
| | Longitudinal Yarn | % | 0.49 | 0.43 | 0.46 | 1.01 | 1.72 |
| | Fineness Variation | | | | | | |
| | Number of Large | spots/ | 0.1 | 0.1 | 0.2 | 0.1 | 0.1 |
| | Diameter Portions | 100,000 m | | | | | |

### Examples 23 and 24, Comparative Examples 9 and 10

Polyester monofilaments were obtained in the same manner as in Example 1 except that the length and inner wall temperature of a heating cylinder was changed as in Table 7. There was a tendency that the shorter the heating cylinder length was, the lower the toughness would be, and that the longer the heating cylinder length was, the larger the longitudinal yarn fineness variation would be. In Examples 23 and 24, both the toughness and the longitudinal yarn fineness variation were good, while in Comparative Example 9, the toughness was significantly low, and in Comparative Example 10, longitudinal yarn fineness variation was significantly high.

### Comparative Example 11

A polyester monofilament was obtained in the same manner as in Example 2 except that the length of a heating cylinder was changed as in Table 7. By lengthening the heating cylinder length, the longitudinal yarn fineness variation became significantly larger. Further, because the fineness was low compared to Example 24 in which the same heating cylinder length was employed, the longitudinal yarn fineness variation became even larger.

### Example 25

A polyester monofilament was obtained in the same manner as in Comparative Example 10 except that the discharge amount per single orifice was changed as in Table 7 such that the fineness was 6.0 dtex. Because the fineness was large compared to Comparative Example 10, the value of longitudinal yarn fineness variation was good even if the heating cylinder length was the same.

The results of Examples 23 to 25 and Comparative Examples 9 to 11 are shown in Table 7.

TABLE 7

| | | | Comparative | Example | Example | Comparative | | Comparative | Example |
|---|---|---|---|---|---|---|---|---|---|
| Item | | Unit | Example 9 | 23 | 24 | Example 10 | Example 2 | Example 11 | 25 |
| Discharge amount per single orifice | | g/min | 1.3 | 1.3 | 1.3 | 1.3 | 1.0 | 1.0 | 1.7 |
| Innner Wall Temperature of the | | ° C. | 299 | 299 | 300 | 300 | 299 | 300 | 300 |
| Heating Cylinder | | | | | | | | | |
| Distance between the Spinnerete face and | | mm | 110 | 170 | 270 | 300 | 170 | 270 | 300 |
| a lower end of the Heating Cylinder L1 | | | | | | | | | |
| Length of the Heating Cylinder L2 | | mm | 40 | 100 | 200 | 230 | 100 | 200 | 230 |
| Distance between the Inner Wall of | | mm | 52 | 52 | 52 | 52 | 52 | 52 | 52 |
| the Heating Cylinder and the Discharge Orifice | | | | | | | | | |
| Take-up Speed | | m/min | 500 | 500 | 500 | 500 | 500 | 500 | 500 |
| Yarn | Fineness | dtex | 4.5 | 4.5 | 4.5 | 4.5 | 3.6 | 3.6 | 6.0 |
| Properties | Strength | cN/dtex | 9.0 | 9.1 | 9.1 | 9.1 | 9.1 | 9.1 | 9.0 |
| | Elongation | % | 10.1 | 13.1 | 13.3 | 13.9 | 12.2 | 12.4 | 13.4 |
| | Toughness | % | 28.6 | 32.9 | 33.2 | 33.9 | 31.8 | 32.0 | 32.9 |
| | Longitudinal Yarn | % | 0.46 | 0.49 | 1.34 | 1.81 | 0.76 | 1.72 | 0.67 |
| | Fineness Variation | | | | | | | | |
| | Number of Large | spots/ | 0.1 | 0.2 | 0.1 | 0.1 | 0.2 | 0.1 | 0.1 |
| | Diameter Portions | 100,000 m | | | | | | | |

### Examples 26 and 27

Polyester monofilaments were obtained in the same manner as in Example 1 except that the inner diameter of a heating cylinder was changed and the distance between the inner wall of the heating cylinder and a discharge orifice was adjusted as in Table 8. There was a tendency that the toughness was reduced and the longitudinal yarn fineness variation became small with increasing distance between the inner wall of the heating cylinder and the discharge orifice. However, both the polyester monofilaments obtained showed a good value of toughness and longitudinal yarn fineness variation.

The results of Examples 26 and 27 are shown in Table 8.

TABLE 8

| | | | Example | Example |
|---|---|---|---|---|
| Item | | Unit | 26 | 27 |
| Discharge amount per single orifice | | g/min | 1.3 | 1.3 |
| Innner Wall Temperature of the | | ° C. | 299 | 299 |
| Heating Cylinder | | | | |
| Distance between the Spinnerete face | | mm | 170 | 170 |
| and a lower end of the | | | | |
| Heating Cylinder L1 | | | | |
| Length of the Heating Cylinder L2 | | mm | 100 | 100 |
| Distance between the Inner Wall of | | mm | 14 | 18 |
| the Heating Cylinder and the | | | | |
| Discharge Orifice | | | | |
| Yarn | Fineness | dtex | 4.5 | 4.5 |
| Properties | Strength | cN/dtex | 9 | 9 |
| | Elongation | % | 14.1 | 13.6 |
| | Toughness | % | 33.8 | 33.2 |
| | Longitudinal Yarn | % | 1.34 | 0.91 |
| | Fineness Variation | | | |
| | Number of Large | spots/ | 0.1 | 0.1 |
| | Diameter Portions | 100,000 m | | |

### Examples 28 to 30

Polyester monofilaments were obtained in the same manner as in Example 1 except that the shape of a die flange at the tip of a screw was changed such that the distance between the tip of the screw of an extruder-type extrusion machine and a pipe wall surface, d1, was as in Table 9. In Example 28, since d2/d1 was low, the extruding pressure at the tip varied, resulting in that the longitudinal yarn fineness variation and the number of large diameter portions were slightly larger than in Example 1. In Example 30, since d2/d1 was low, the number of large diameter portions increased compared to Example 1.

The results of Examples 28 to 30 are shown in Table 9.

TABLE 9

| Item | | Unit | Example 28 | Example 1 | Example 29 | Example 30 |
|---|---|---|---|---|---|---|
| Final Groove Depth of Extruder Screw d2 | | mm | 1.6 | 1.6 | 1.6 | 1.6 |
| Distance between a Tip of the Extruder Screw | | mm | 0.8 | 1.5 | 2.5 | 4.0 |
| and a Pipe Wall Surface d1 | | | | | | |
| d2/d1 | | mm | 2 | 1.1 | 0.6 | 0.4 |
| Yarn | Fineness | dtex | 4.5 | 4.5 | 4.5 | 4.5 |
| Properties | Strength | cN/dtex | 9.1 | 9.1 | 9.1 | 9.0 |
| | Elongation | % | 13.0 | 13.1 | 12.9 | 13.1 |
| | Toughness | % | 32.8 | 32.9 | 32.7 | 32.6 |
| | Longitudinal Yarn | % | 1.10 | 0.49 | 0.51 | 0.71 |
| | Fineness Variation | | | | | |
| | Number of Large | spots/ | 2.1 | 0.1 | 0.6 | 12.5 |
| | Diameter Portions | 100,000 m | | | | |

### INDUSTRIAL APPLICABILITY

The monofilament for screen mesh cloth obtained by the present invention and the screen mesh cloth obtained therefrom can be used in highly precise screen printing. Further, the woven fabric obtained from the monofilament for screen mesh cloth of the present invention can be suitably used also as a mesh material such as an filter.

### DESCRIPTION OF SYMBOLS

1: Extruder

2: Spin pack

3: Bicomponent spinneret

4: Heating cylinder

5: Yarn cooling apparatus

6: Oiling roll

7: Godet roll 1

8: Hot roll 2

9: Hot roll 3

10: Hot roll 4

11: Godet roll 5

12: Yarn winding apparatus

1. A core-sheath bicomponent polyester monofilament, wherein a core component is composed of polyethylene terephthalate and a sheath component is composed of polyethylene terephthalate having an intrinsic viscosity (IV) at least 0.2 lower than that of the core component, the polyester monofilament having a fineness of 3 to 8 dtex, a strength of 7.5 cN/dtex or more, a toughness (strength×elongation^{0.5}) of 29 or more, and a longitudinal yarn fineness variation of 1.5% or less.

2. The polyester monofilament according to claim 1, wherein large diameter portions which are at least 20% larger than the average fiber diameter of a monofilament cross-section are present at a frequency of not more than 1 in 100,000 m.

3. A method for producing a polyester monofilament having a fineness of 3 to 8 dtex, wherein each polyethylene terephthalate of the core component and the sheath component is individually molten; yarn which is spun through a bicomponent spinneret via a spin pack mounted on a spin block is passed through a heating cylinder which is arranged immediately below a spinneret face and sequentially with the spin block, solidified by cooling, and provided with a spinning oil solution; and undrawn yarn taken up by a take-up roll is drawn without once being wound and then wound; these steps being performed under conditions where a temperature of an inner wall of the heating cylinder, T, is 270 to 325° C., a distance between the spinneret face and a lower end of the heating cylinder, L1, and a length of the heating cylinder, L2, satisfy the following equation, and a speed of the take-up roll is 300 to 800 m/min:
120≦L1 (mm)≦(−0.78×Q−2.56)×T+(294×Q+980)50≦L2 (mm)
Q: discharge amount per discharge orifice (g/min)
T: temperature of inner wall of heating cylinder (° C.).

4. The method for producing a polyester monofilament according to claim 3, wherein total drawing magnification is 4.5 to 7.0 times and drawing magnification at a first stage is 50 to 80% of the total drawing magnification.

5. The method for producing a polyester monofilament according to claim 3 or 4, wherein an extruder-type extrusion machine is used in melting the polyethylene terephthalate of the core component and/or the sheath component, and a ratio of a final groove depth of an extruder screw, d2, to a distance between a tip of the extruder screw and a pipe wall surface, d1, d2/d1, is 0.5 to 1.5.

6. A method for producing screen mesh cloth in which the polyester monofilament according to claim 1 or 2 is used in an amount of 50 wt. % or more based on warp and/or weft.
